(19) United States
(12) Patent Application Publication
(10) Pub. No.: US 2005/0135259 A1
(43) Pub. Date: Jun. 23, 2005

(54) Hand-held electronic tester for telecommunications networks

(76) Inventors: Sami Yazdi, Beaconsfield (CA); Nando Di Giambattista, Montreal (CA); Patrick Ostiguy, Lachine (CA); Giovanni Forte, Pointe-Claire (CA)

Correspondence Address: ST. ONGE STEWARD JOHNSTON & REENS, LLC, 986 BEDFORD STREET, STAMFORD, CT, 06905-5619, US

(21) Appl. No.: 10/969,093

(22) Filed: Oct. 20, 2004

Related U.S. Application Data
(62) Division of application No. 09/587,536, filed on Jun. 5, 2000.

(51) Int. Cl. H04L 12/26

(52) U.S. Cl. 370/241

(57) ABSTRACT

The present invention concerns a portable, field-oriented test gear which permits validation of both digital circuit (TOM) and packet based communications. The test set includes a method and graphical user interface for configuring OSI, 0S3, SONET and packet communication based tests, a method and system that allows testing an Ethernet WAN link by using a Pseudo-Random Bit Sequence (PRBS) pattern, as well as a method and system to remotely validate full-duplex 10/100/1 000BaseTX WAN communication at full line rate (1 Gbps) using a single test gear and a low cost accessory included with the test gear.

### FIELD OF THE INVENTION

The present invention relates to test instrumentation in general and more specifically to instrumentation for testing Digital Circuit (Time Division Multiplex: TDM) and Packet based communication networks.

### BACKGROUND OF THE INVENTION

Digital Circuit (Time Division Multiplex, or TDM) based communications is now the established technology for the carriage of voice, data and video communications. The advent and rapid growth in popularity of the internet and of the TCP/IP protocol has spurred the need for an infrastructure that is better optimized for packet based communications.

Consequently, manufacturers of fiber optic networking equipment have started to address this transition by incorporating packet communication interfaces such as Ethernet on their traditional digital circuit (TDM) fiber optics networking equipment. Since a broad established customer base still uses TDM technology, manufacturers are offering both TDM and packet technologies on the same networking equipment.

Telecommunication carriers, which used to install only TOM based infrastructures, are now building hybrid TDM/Packet based networks and consequently, their field installation technicians need to test both technologies on the same networking equipment in the same physical location.

TOM test instruments and packet communication test instruments typically consist of two separate physical and logical entities, which thus reduces the portability versatility and usability of such devices when these two technologies converge. The convergence of TOM based and packet based technologies in the fiber optics communication industry requires an instrument that enables testing both of those two technologies simultaneously, as well as the interaction and integration of both, e.g. testing packet over SONET (POS) communication.

Furthermore, test instruments capable of testing full-duplex 10/100/1 000BaseTX packet based networks at its full-line-rate (1 Gbps) typically require the connection of a separate personal computer (PC), monitor, keyboard and mouse to allow configuring it and operating the user interface, thus reducing the portability and usability of the device.

Testing the various TOM signal hierarchies of digital circuit based communications (DS1, DS3, STS-1, OC-3, etc.) can become very complicated if the testing configurations have to be set up using a complex user interface. Since portable test instruments include a broad range of TOM test functions, the former dials, buttons and function keys of the prior art test devices have now become ineffective and result in an unfriendly and cumbersome user interface.

Others have proposed Graphical User Interfaces (GUI) for the configuration of TOM communication test devices. For example, U.S. Pat. No. 5,808,920 to Zwan et al. discloses a GUI interface that can be used in conjunction with a TOM communication test device. However, the interface uses a graphical representation of the specific physical test device being used, which requires knowledge and understanding of the internal architecture of that specific physical test device (internal switch matrix, various processors and modules, etc.)

U.S. Pat. No. 5,619,489 to Chang et al. discloses a portable TOM communication test device that incorporates a graphical display, a user input device, as well as a graphical method for changing the test configuration of the device. However, the user input device consists of pushbuttons and function keys as opposed to a touchscreen.

### SUMMARY OF THE INVENTION

It is therefore an object of the invention to provide a field-oriented test set which permits validation of both digital circuit (TOM) and packet based communications that obviates the deficiencies noted in the prior art.

More specifically, it is an object of the invention to provide a configuration method and graphical user interface for configuring DS1, DS3, SONET and Packet Communication based tests.

It is a further object of the invention to provide a graphical user interface that includes a configuration scheme based on the standard TOM multiplexing hierarchy.

It is a further object of the invention to provide a graphical user interface that includes a scheme that always uses the communication signal connected to the test set as a starting point for intuitive configuration.

It is a further object of the invention to provide a graphical user interface which establishes a scheme that allows the user to activate any TDM test case configuration by using a minimum number of touches on the touchscreen icons of the test set (or clicks of a mouse).

It is a further object of the invention to provide a graphical user interface that guides the user after the first touch of a touchscreen icon (or first click of a mouse) by highlighting the valid options for the second touch of a touchscreen icon (or click of a mouse).

It is a further object of the invention to provide an all inclusive (hardware device, computer and user interface), portable test platform capable of testing 10/100/1000BaseTX communication at full line rate (1 Gbps) for all packet sizes and capable of remote communication to a second test set via the Ethernet link under test.

It is a further object of the invention to provide a method and system for testing a full duplex bidirectional 10/100/1000BaseTX WAN link by using only a single test set and a special Ethernet loopback accessory.

It is a further object of the invention to provide an all-inclusive (hardware device, computer and user interface), portable test platform capable of testing packet communication embedded inside a packet over SONET (POS) link.

It is a further object of the invention to provide an all inclusive (hardware device, computer and user interface), portable test platform capable of dropping packet communications from a POS link to an Ethernet interface.

It is a further object of the invention to provide a method and system for testing an Ethernet WAN link by using a Pseudo-Random Bit Sequence (PRBS) pattern in order to count bit errors and derive a Bit Error Rate (BER).

In accordance with one aspect of the invention, there is provided a portable, field oriented test set for testing TOM and packet based communication networks, comprising:
a mother module, for managing the test set;
a TOM module, operatively connected to the mother module and to a plurality of physical connectors, said TOM module being adapted to perform test sequences on digital circuit networks;
a packet communication test module, operatively connected to the mother module, to the TOM module:and to at least one 10/100/1000BaseTX connector, said packet communication test module being adapted to perform test sequences on packet based communications networks; a display area for displaying information relative to the tests under way and to provide information with respect to the test set;
input devices, for inputting information into said test set; and a GUI for interfacing between said test set and a user, whereby said test set is adapted to test TOM communication networks and packet based communication networks.

In accordance with another aspect of the invention, there is provided a graphical user: interface for a test set being adapted to perform testing on a plurality of communications channels, said GUI comprising:
a display comprising a signal area, a circuit area and a test area; said signal area displaying icons related to the physical communications channels;
said circuit area displaying icons related to standard multiplexing steps associated with said signal area icons; and
said test area displaying icons related to the test to be executed, wherein when said test set is physically connected to a physical communication channel, an icon in the signal area representing said physical communication channel is highlighted, and icons in the circuit area and the test area related to the icon representing the physical communication channel, and representing valid circuits or tests associated with the physical communication channel are highlighted, so that a user can only select a valid circuit or test icon.

Another aspect of the invention is concerned with a loopback accessory for testing a full duplex Ethernet WAN link with a test set, said accessory including: an interface for receiving Ethernet packets from a communications network, an Ethernet MAC Controller for delineating destination and source MAC addresses of a packet; an inverter for inverting the destination and source MAC addresses and for creating another packet with the inverted destination and source-addresses; said accessory transmitting the other packet over said communications network.

The invention also provides a method for testing full duplex Ethernet WAN links, comprising:
preparing a packet including destination and source MAC addresses with a test set, and time-stamping said packet with said test set;
sending said packet over a communications network to a loopback accessory;
receiving said packet with said loopback accessory;
inverting said source and destination MAC addresses with said loopback accessory and accordingly preparing another packet;
sending said other packet from said loopback accessory to said test set over said communications network;
receiving said other packet with said test set; and analysing said packet with said test set to extract relevant information.

The system for testing full duplex 10/100/1000BaseTX communications links according to yet another aspect of the invention comprises:
a test set for preparing and sending over the communications link a packet including destination and source MAC addresses, and for time-stamping said packet; and
a loopback accessory for receiving the packet, inverting the destination and source MAC addresses, preparing another packet with the destination and source MAC addresses so inverted and transmitting the other packet over the communications link to the test set.

Finally, a method for testing an Ethernet link is disclosed comprising:
(a) generating a PRBS test pattern and filling the data portion of a flow of Ethernet packets with the PRBS test pattern using a first test set;
(b) transmitting said packets from said first test set to a second test set over an Ethernet TLS link;
(c) extracting and obtaining a resulting PRBS test pattern from the packets received at a second test set, the resulting pattern allowing for a precise count of bit errors, thereby providing a bit error rate.

### BRIEF DESCRIPTION OF THE DRAWINGS

The present invention will be better understood after reading the following description of preferred embodiments thereof, made in reference to the appended drawings in which:

FIG. 1 is a schematic representation of the front view of the test set according to the present invention;

FIG. 2 is a schematic representation of the rear view of the test set of FIG. 1;

FIG. 3 is a schematic representation of a loopback accessory for use with the test set of the present invention;

FIGS. 4 to 13 are illustrations of the graphical user interface according to a preferred embodiment of the present invention;

FIG. 14 is a schematic representation of a communication through Ethernet link under test;

FIG. 15 is a schematic representation of a method of testing a network using the loopback accessory of FIG. 3;

FIG. 16 is a schematic representation of the architecture of the loopback accessory;

FIG. 17 is a block diagram of the architecture of the test set;

FIG. 18 is a block diagram of the TDM communication module;

FIG. 19 is a block diagram of the mother module;

FIG. 20 is a block diagram of the packet communication module; and

FIG. 21 is a flow chart of the method for performing a BER test on Ethernet according to the present invention.

### DESCRIPTION OF PREFERRED EMBODIMENTS OF THE INVENTION

The present invention concerns a portable, field-oriented test gear which permits validation of both digital circuit (TDM) and packet based communications. The invention, broadly stated, comprises a configuration method and graphical user interface for configuring DS1, DS3, SONET and packet communication based tests, as well as a method and system to remotely validate full-duplex 10/100/1000BaseTX Wide Area Network (WAN) communication at full line rate (1 Gbps) using a single test gear and a low cost accessory included with the test gear.

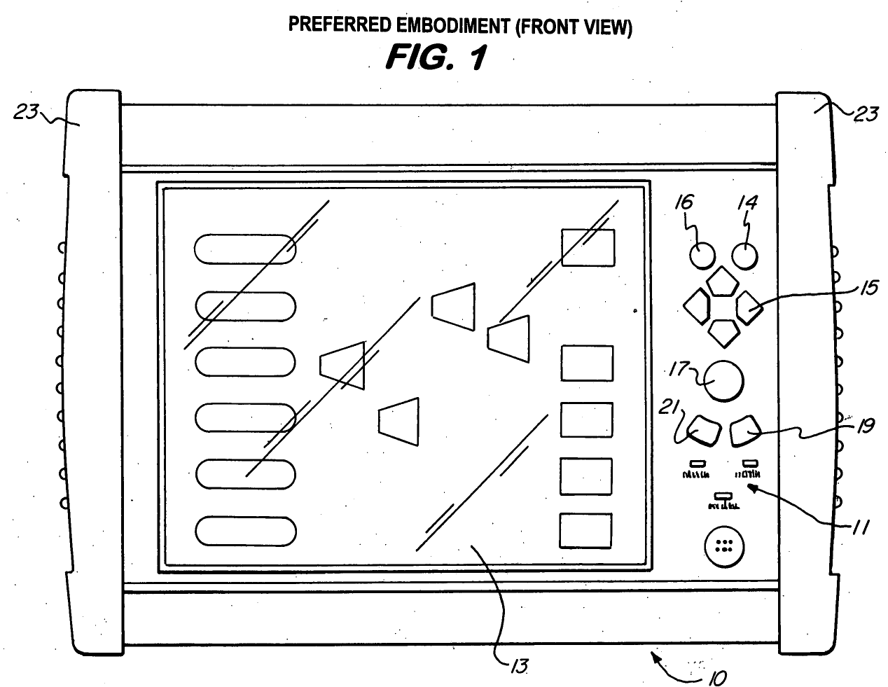

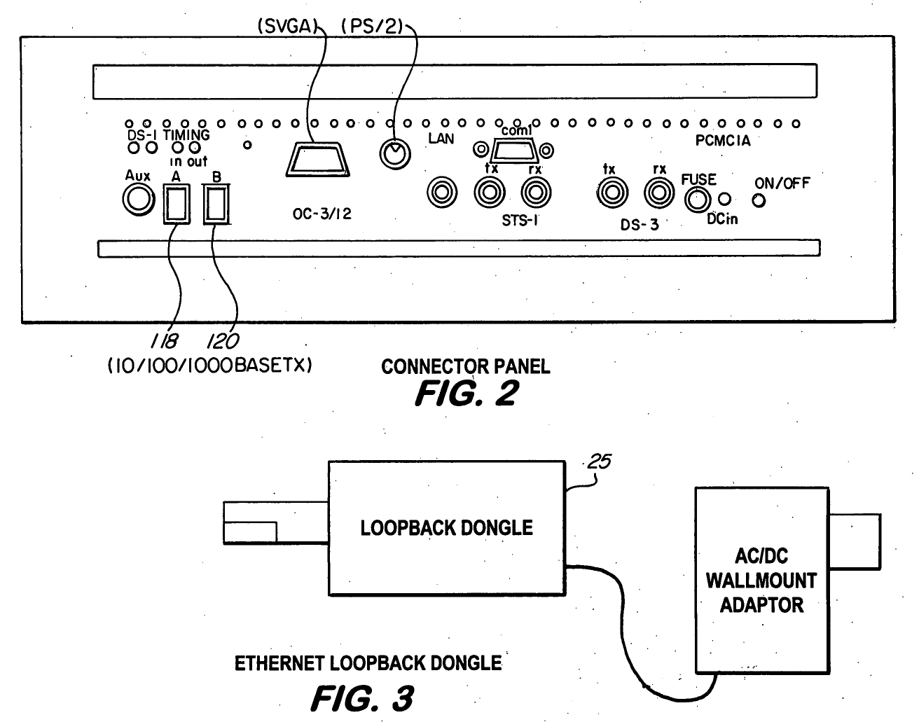

An external representation of the preferred embodiment of the present invention is shown in FIG. 1. The test set 10 preferably includes LEDs 11, an LCD graphical display with a touchscreen overlay 13, arrow keys 15, an enter key 14, a help key 16, a pointing device 17, a right mouse button 19, a left mouse button 21, rubberized protective endcaps 23, a connector field shown in FIG. 2. In order to more fully benefit from the advantages of the test set, an external loopback accessory 25 is preferably provided with the test set 10, as will be hereinafter detailed.

LEDs 11 display the summary conditions of the test set (Alarm, History, Power), LCD display 13 displays the test configuration, test results, detailed alarm conditions and acts as an input device through the use of an overlaid touchscreen. Arrow keys 15 allow for movement of the text cursor within text fields, the enter key 14 is used to confirm the entry of text information in text fields. The help key 16 is used by the user to instantly access context sensitive help information text. The pointing device 17 may be used as an alternative to the touchscreen to control a graphical pointer for inputting configuration, the right mouse button 19 being used to select an object pointed by the pointing device, and the left mouse button 21 being used to popup a context sensitive pulldown menu.

Rubberized protective endcaps 23 protect the test set case from shocks and other handling risks.

The connector panel located at the rear of the test set 10 includes the several connectors used to connect the test set with external communication media, as is well known in the art.

In a preferred embodiment, the test set weighs approximately 10 pounds, which is appropriate for hand-held use.

The external loopback accessory 25 is used to assist the user in executing a full-duplex bidirectional 10/100/1000BaseTX WAN link test, requiring only a single test set, using the method described hereinafter.

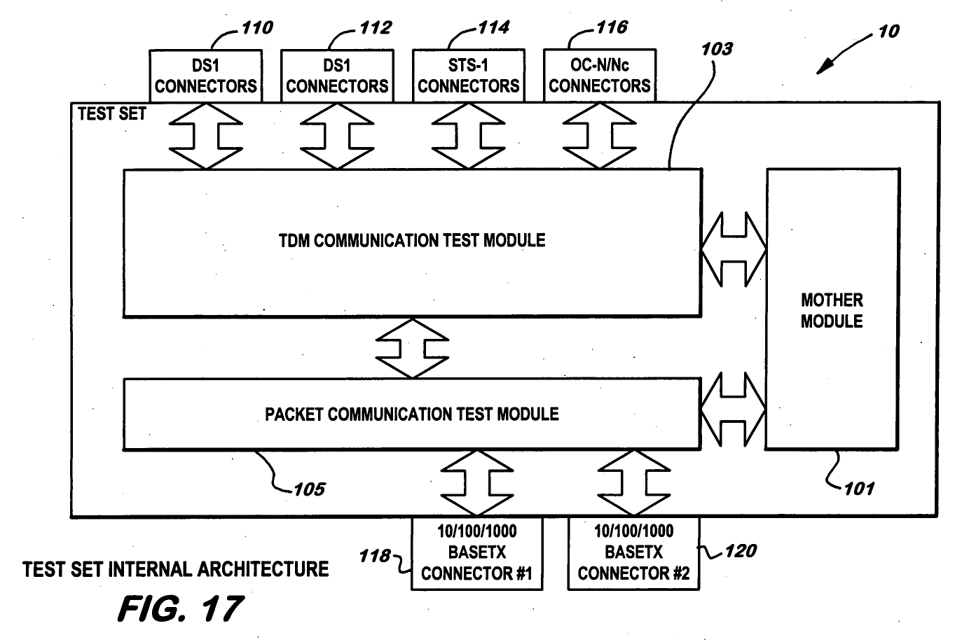

FIG. 17 shows a high level block diagram of the internal architecture of the test set 10 according to a preferred embodiment of the present invention. The test set 10 is comprised of three main modules: the mother module 101, the TOM communication test module 103 and the packet communication test Module 105.

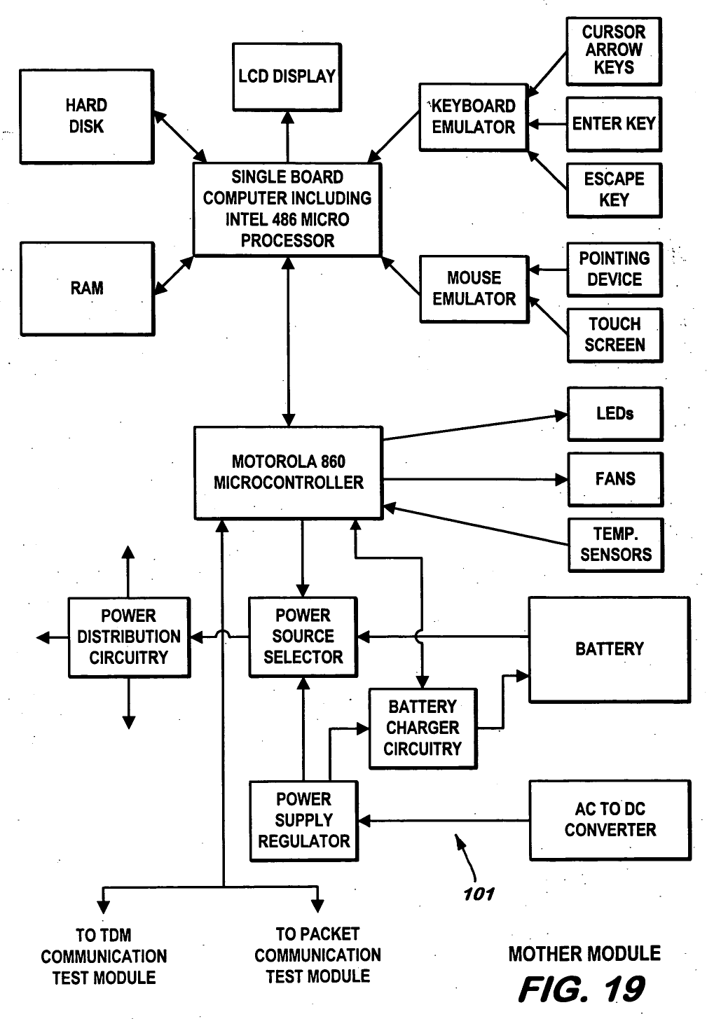

The mother module 101, shown in more detail in FIG. 19, is responsible for the hardware management of the graphical user interface (GUI), the memory and data stocking capabilities, user input devices, as well as general “housekeeping” functions such as internal temperature control of the test device, power regulation and distribution and battery management and charging. This module 101 also hosts the main controller unit and is connected to the TOM communication test module 103 and packet communication test module 105 in order to control them.

The TDM communication test module 103 provides the ability to perform various test sequences on digital circuit (TDM) networks, namely, providing functions for DS1, DS3, and SONET digital circuit testing.

The packet communication test module 105 provides the ability to perform various test sequences on packet based communication networks, namely, providing functions for 10/100/1000BaseTX and Packet Over SONET (POS) based communications.

The TDM communication test module 103 can be connected to the external TDM communication media via the various TDM communication connectors, namely the DS1 110, DS3 112, STS-1 114, and OC-N/Nc 116 connectors.

The packet communication test module 105 can be connected to the external packet communication media via the two (2) 10/100/1000BaseTX connectors 118 and 120. The packet communication test module 105 is also connected to the TDM communication test module 103.

Since telecommunication carriers are now building hybrid TOM/Packet based networks (or “multi-service” Networks), their field installation technicians need to test both technologies on the same networking equipment in the same physical location during the same period of time required for installation of such equipment. Therefore, the present invention advantageously incorporates both TOM communication testing and packet communication testing in a single field portable, standalone packaging. This results in significant savings for technicians involved in the turn-up and troubleshooting of communication network equipment.

Additionally, in many communication networks, packet based communications are also carried within digital circuits (TOM). As an example, packet over SONET (POS) communication consists of data packets carried within a TDM circuit of SONET format. In order to allow testing of such communications networks, the present invention advantageously includes a link between the TDM communication test module and the packet communication test module. This link provides the test set 10 of the present invention with the unique ability to perform testing of packet communications embedded inside POS in an all inclusive (test device, computer and user interface), portable, field oriented test platform.

The aforementioned link between the TDM and Packet Communication test module also permits the user to direct packet communication coming from within a TDM signal and drop it out of the test equipment on the Ethernet interfaces. This feature for an all inclusive instrument permits the user, for instance, to validate the SONET mapping functions of an external network element such as a POS multiplexer. Accordingly, the packet communication test module must first generate a packet stream. The packet stream is then sent to the TDM communication test module, which then maps these packets within a SONET STS-Nc signal. The mapped packets are sent out of the test device to the external network element. The external network element de-maps the packet stream from the SONET STS-Nc signal and returns it in its native format to the packet communication test module via one of the 10/100/1000BaseTX interfaces. This test configuration allows the user to measure the latency added to the packet stream by the POS multiplexer.

Each of the main modules of the test set 10 of the present invention will now be detailed.

Referring now, to FIG. 19, the mother module 101 is responsible for the hardware management of the GUI, the memory and data stocking capabilities, user input devices as well as general “housekeeping” functions such as internal temperature control of the test device, power regulation and distribution and battery management and charging, as well as other inherent tasks. This module also hosts the main controller unit and connects it to the TOM communication test module 103 and packet communication test module 105.

According to the preferred embodiment of the present invention, the mother module 101 comprises:
a commercially available “single-board-computer” (SBC) including an Intel 486 microprocessor used to run the Graphical User Interface (GUI);
an LCD color display connected to the SBC to display the GUI to the user;
a portable-computer-grade hard disk drive connected to the SBC to keep the Operating System, the GUI software and to store the information gathered during the tests;
RAM memory (32 MB) connected to the SBC to allow it to run the operating system and the GUI (software);
enter, escape and cursor arrow keys linked to the SBC via a keyboard emulator component to facilitate the user navigation through available text such as online-help files;
a pointing device and a touch screen linked, to the SBC via a mouse emulator component to facilitate the user navigation through the GUI;
a Motorola 860 micro-controller used to control the front panel LEDs of the unit, manage internal temperature of the test device via sensors and fans, manage power supply distribution and battery charging and control the TOM and packet communication test modules 103 and 105;
LEDs to inform the user of alarm conditions during the test;
temperature sensors to inform the 860 micro-controller of the internal temperature of the test device;
fans controlled by the microprocessor to reduce the internal temperature of the test device;
an AC/DC power converter used to convert AC power from the sector to DC for internal distribution within the test device;
a power supply regulator to regulate the DC power being fed to the test device;
a battery charger circuitry controlled by the 860 microprocessor which uses power given by the regulator to charge the battery;
a battery that can be used as an alternative power source to allow more mobility to the test device;
a power source selector controlled by the 860˜microprocessor to toggle between the battery feed and the DC power supply regulator in the event of a battery or AC feed failure;
power distribution circuitry to distribute power throughout the test device to the various components;
a communication link between the 860 micro-controller and the TOM and packet communication test modules 103 and 105 to control the execution of the various tests; and
a communication link between the 860 micro-controller and the SBC to communicate the test results gathered by the 860 micro-controller to the GUI for presentation to the user and to allow the user to control the execution of the tests.

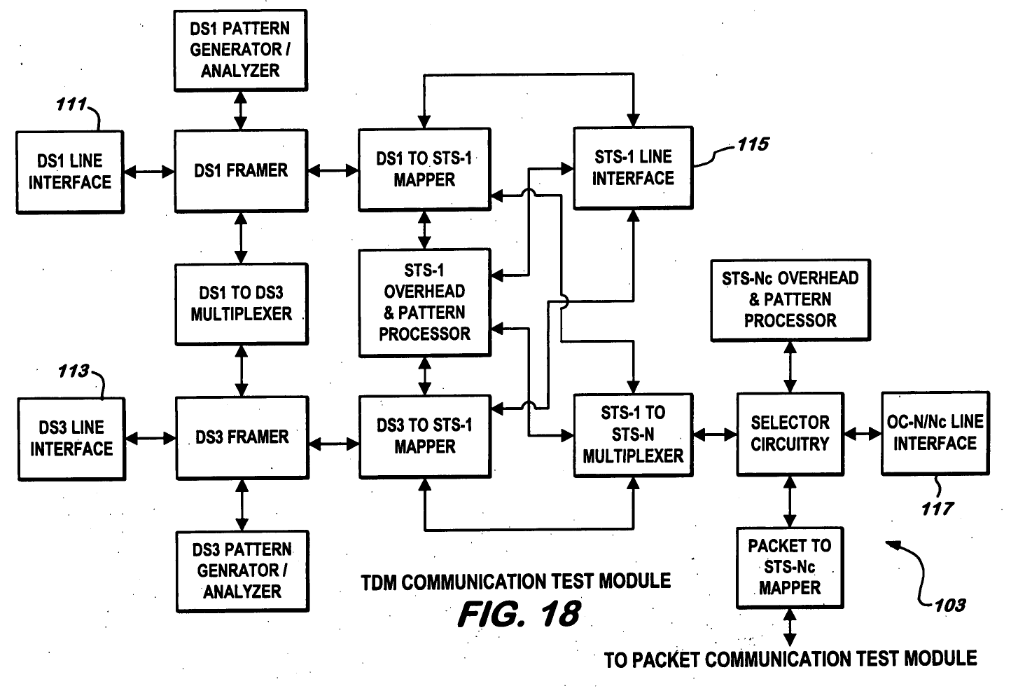

The TDM communication test module 103 is shown in FIG. 18. The TOM communication test module allows the user to execute test routines on TOM communication protocols such as DS1, DS3, and SONET, as well as demultiplexing functions to allow executing test routines on TDM signals when they are a sub-rate of a higher frequency TOM signal, for example, running a test on a DS1 which was incorporated in a DS3 which was incorporated in an STS-1 which was part of an OC-3 signal.

The TOM communication test module 103, in a preferred embodiment of the invention, comprises:
a “DS1 line interface” that allows conversion of DS1 signal levels coming from a digital network communication transmission line to electrical signal levels suitable for board level processing and vice-versa, the “DS 1 line interface” being connected to a “DS1 Framer”;
a “DS3 line interface” that allows conversion of DS3 signal levels coming from a digital network communication transmission line to electrical signal levels suitable for board level processing and vice-versa, the “DS3 line interface” being connected to a “DS3 Framer”;
a “DS1 Pattern Generator/Analyzer” used to generate and analyze pseudo-random bit sequences which are used to stress-test DS1 digital communication lines, the “DS1 Pattern Generator/Analyzer” being connected to the “DS1 Framer”;
a “DS1 Framer” used to add the DS3 framing protocol to the raw bit sequence coming from the “DS3 Pattern Generator/Analyzer” and send it to the “DS3 Line Interface”, or to remove the DS3 framing protocol from the DS3 signal coming from the “DS3 Line Interface” and send the raw bit sequence to the “DS3 Pattern Generator/Analyzer”. The “DS3 Framer” is also connected to the “DS3 to STS-1 Mapper” and to the “DS1 to DS3 Multiplexer” for the same purpose as with the “DS1 Line Interface”;
a “DS1 to DS3 Multiplexer” used to insert/extract a single DS1 in/out of a higher frequency DS3 signal. The “DS1 to DS3 Multiplexer” is also connected to the “DS3 Framer”;
a “DS3 Framer” used to add the DS3 framing protocol to the raw bit sequence coming from the “DS3 Pattern Generator/Analyzer” and send it to the “DS3 Line Interface”, or to remove the DS3 framing protocol from the DS3 signal coming from the “DS3 Line Interface” and send the raw bit sequence to the “DS3 Pattern Generator/Analyzer”. The “DS3 Framer” is also connected to the “DS3 to STS-1 Mapper” and to the “DS1 to DS3 Multiplexer” for the same purpose as with the “DS3 Line Interface”;
a “DS3 Pattern Generator/Analyzer” used to generate and analyze pseudo-random bit sequences which are used to stress-test DS3 digital communication lines, the “DS3 Pattern Generator/Analyzer” being connected to the “DS3 Framer”;
a “DS1 to STS-1 Mapper” is used to map/de-map a DS1 signal to/from an STS-1 SONET signal. The “DS1 to STS-1 Mapper” is also connected to the “STS-1 line Interface”, to the “STS-1 Overhead & Pattern Processor” and to the “STS-1 to STS-N Multiplexer”;
an “STS-1 Overhead & Pattern Processor” used to generate/analyze SONET overhead and pseudo-random bit sequences to/from a SONET STS-1 signal. The “STS-1 Overhead & Pattern Processor” is also connected to the “STS-1 Line Interface” for analyzing an STS-1 signal coming directly from an STS-1 digital communication line, to the “DS1 to STS-1 Mapper” for analyzing an STS-1 signal which has embedded therein OSI signals, to the “DS3 to STS-1 Mapper” for analyzing an STS-1 signal which has an embedded DS3 signal, and to the “STS-1 to STS-N Multiplexer” for analyzing an STS-1 signal which was embedded in an STS-N signal;
a “DS3 to STS-1 Mapper” is used to map/demap a DS3 signal to/from an STS-1 SONET signal. The “DS3 to STS-1 Mapper” is also connected to the “STS-1 line Interface”, to the “STS-1 Overhead & Pattern Processor” and to the “STS-1 to STS-N Multiplexer”;
an “STS-1 line interface” that allows conversion of STS-1 signal levels coming from a digital network communication transmission line to electrical signal levels suitable for board level processing and vice-versa;
an “STS-1 to STS-N Multiplexer” used to insert/extract a single STS-1 in/out of a higher frequency STS-N signal. The “STS-1 to STS-N Multiplexer” is also connected to the “Selector Circuitry”;
an “STS-Nc Overhead & Pattern Processor” used to generate/analyze SONET overhead and pseudo-random bit sequences to/from a SONET STS-Nc signal. The “STS-Nc Overhead & Pattern Processor” can be connected to the “OC-N/Nc Line Interface” via the “Selector Circuitry”;
a “Selector Circuitry” that can be used to connect the STS-N/Nc signal coming from the “OC-N/Nc Line Interface” to the “STS-1 to STS-N Multiplexer”, or to the “STS-Nc Overhead & Pattern Processor”, or to the “Packet to STS-Nc Mapper”;
an “OC-N/Nc Line Interface” that allows conversion of OC-N/Nc optical signals coming from a fiber optics transmission media to STS-N/Nc electrical signal levels suitable for board level processing and vice-versa; and
a “Packet to STS-Nc Mapper” used to map/de-map the packets to/from the “Packet Communication Test Module” into a SONET STS-Nc protocol format. This component is also connected to the “Selector Circuitry” in order to send the STS-Nc signal to the “OC-N/Nc Line Interface”.

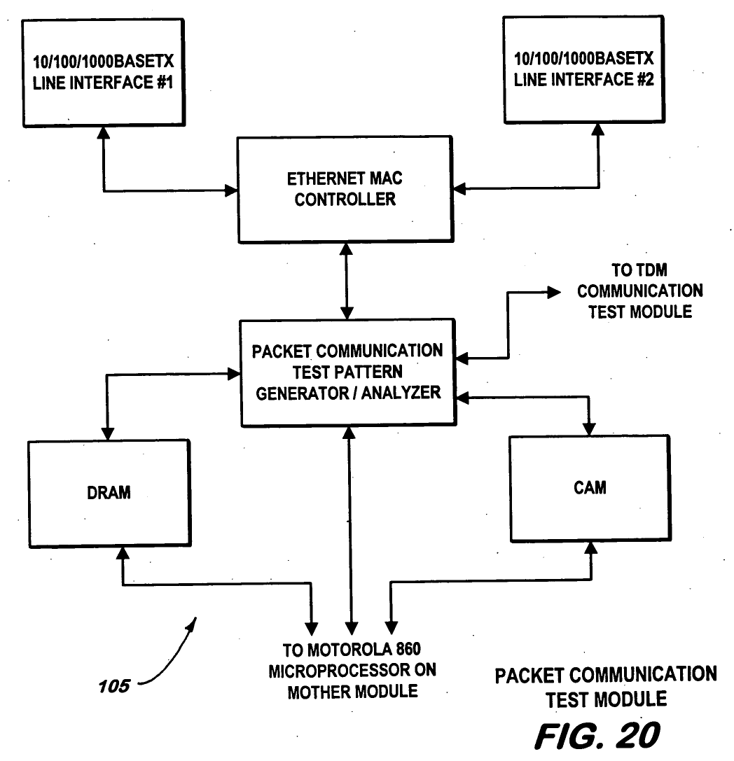

The packet communication test module is shown in FIG. 20 and allows the user to execute test routines on packet communication protocols such as Ethernet and PoS.

The packet communication test module comprises:
a “Packet Communication Test Pattern Generator/Analyzer” used to generate and analyze packet communication test patterns. This component is adapted to generate and capture packets at a rate of up to 1 Gigabit per second, thus allowing stressing Ethernet communications at their maximum capacity. This component also allows tagging and verification of packets to verify their source address for latency, burstability, packet loss and throughput measurements. This component is connected to the “Ethernet MAC Controller”, to the “DRAM”, to the “CAM”, to the Motorola 860 microprocessor on the mother module 101, and to the TDM communication test module 103;
an “Ethernet MAC Controller” receiving the packets coming from the “10/100/1000BaseTX Line Interfaces” and validating the CRC-32 Frame Check Sequence (FCS) on them. This component is also responsible for validating the destination MAC addresses of the incoming packets, as well as managing Ethernet CSMA/CO (Carrier Sense Multiple Access/Collision Detect) collisions (for Half Duplex). This component is connected to the two “10/100/1000BaseTX Line Interfaces” 118, 120;
two “10/100/1000BaseTX Line Interfaces” 118, 120 that allow conversion of Ethernet signal levels coming from 10/100/1000BaseTX transmission media to electrical signal levels suitable for board level processing and vice-versa;
DRAM (Dynamic RAM) used to allow buffering of the packet stream between the “Packet Communication Test Pattern Generator/Analyser” and the Motorola 860 microprocessor on the mother module 101; and
CAM (Content Addressable Memory) used to allow the Motorola 860 microprocessor on the mother module 101 to filter packets coming to/from the “Packet Communication Test Pattern Generator/Analyser”.

It should be understood however that a variety of alternative, supplemental or other configurations for each of the above detailed modules are well within the scope of the present invention. The components described above have been for illustration purposes only, and are not intended to limit the scope of the appended claims.

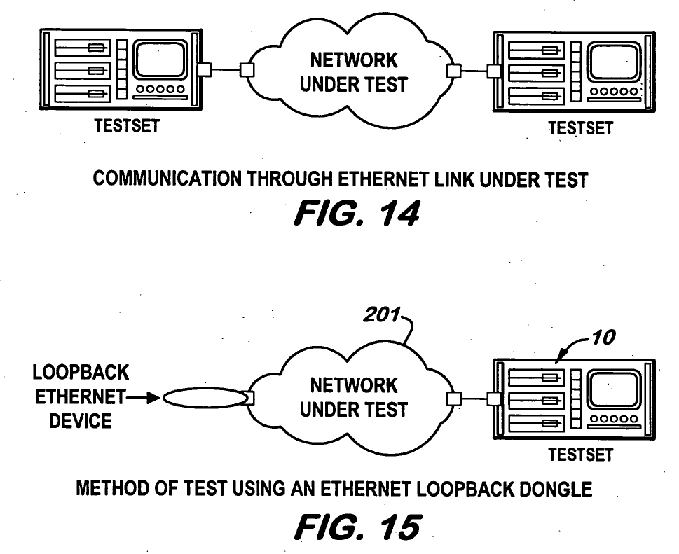

FIGS. 14 and 15 show block diagrams of two preferred embodiments used to test a 10/100/1000BaseTX link. It is an advantageous aspect of the invention to provide an all inclusive (hardware device, computer and user interface), portable test platform capable of testing 10/100/1000BaseTX communication at full line rate (1 Gbps) for all packet sizes and capable of remote communication to a second test device via the actual Ethernet link under test. The use of two test sets is mandatory when the Ethernet media under test is of half duplex nature and if the Ethernet link spans over two different sites. However, when testing full duplex, or when the Ethernet link does not span over two different sites, it will be seen that only one test set is required.

Communicating through the Ethernet link under test permits a test set to coordinate a test sequence with the remote counterpart, which is not possible with the prior art devices designed for lab applications.

In order for the communication between the test devices not to affect the test underway (which would alter the measurements), the method used is simply to engage communication between the two test devices only before the actual test starts (to communicate the parameters of the test to be done) and once the tests and measurements are actually finished (to communicate the results of the test).

Alternatively, an external loopback accessory 25 is used to assist the user in executing a full-duplex bidirectional 10/100/1000BaseTX WAN link test using only a single test set as per the method described below.

FIG. 15 shows a block diagram of the setup used to test a 10/100/1000BaseTX full duplex link using the Ethernet loopback accessory 25. This aspect of the present invention results in significant savings to those engaged in turn-up and troubleshooting of such networks, since the cost of such an accessory is far less than the cost of a second test set.

The method for performing such a test is, according to a preferred embodiment of the present invention as follows. The packets are first time-stamped inside the test set 10 and sent from the test set (at the right of FIG. 15) through the network under test 201. Once the packets have traveled through the network under test, they are received by the loopback accessory (at the left of FIG. 15). The purpose of the accessory is to modify every packet received by swapping their source MAC addresses and their destination MAC addresses, and then send them back through the network under test towards the test set. The test set then receives the original packets with the modified addresses and compares the original time-stamp to the test set's current time to derive the round-trip latency calculation. Even more advantageously, to allow a more accurate measurement, the test set also subtracts a fixed constant value associated with the latency added by the loopback accessory 25 circuitry itself.

The same accessory 25 and connection method can also be used when measuring throughput, burstability and amount of packet loss as part of RFC 1944 and RFC 1242 Ethernet standards. It should be noted that the use of this novel loopback accessory method for measuring those standards based parameters also falls within the scope of the present invention.

It is important to mention that this method would not be applicable to a switched Ethernet network under test if the accessory 25 did not have the ability to swap the source and destination MAC address of the packets. The remote Ethernet port would not allow the re-insertion in the network of a packet having its own address as a MAC destination; instead, it would reject the packet and the packet would never make its way back to the originating test set.

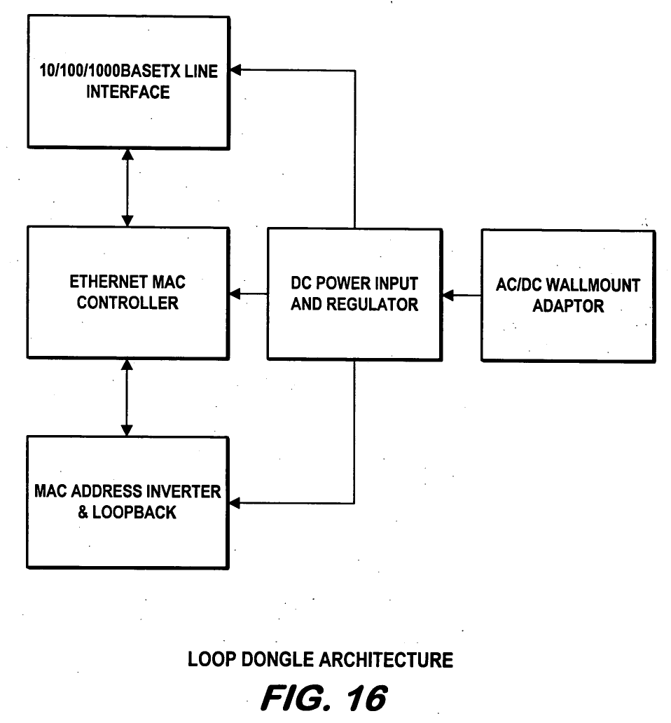

In order to accomplish this, the loopback accessory 25 must have an architecture which allows it to have the above-noted functionalities. FIG. 16 shows a block diagram of the architecture of the loopback accessory 25, which comprises:
a “10/100/1000BaseTX Line Interface” that allows conversion of Ethernet signal levels coming from 10/100/1000BaseTX transmission media to electrical signal levels suitable for board level processing and vice-versa. This component is connected to the “Ethernet MAC Controller”;
an “Ethernet MAC Controller” used to delineate the destination and source MAC addresses of the Ethernet packets received from the “10/100/1 000BaseTX Line Interface” and to transfer this delineation information as well as the Ethernet packets themselves to the “MAC Address Inverter and Loopback”;
a “MAC Address Inverter and Loopback” component used to invert the destination and source MAC addresses of the received Ethernet packets and send them back to the “Ethernet MAC Controller”;
a “DC Power Input and Regulator” used to regulate the DC power input coming from the external “AC/DC Wallmount Adapter” and to distribute it to the internal components of the dongle; and
an external “AC/DC Wallmount Adapter” used to convert AC Power from the sector to DC power usable by the “DC Power Input and Regulator”.

A further aspect of the present invention consists in a method and system for testing an Ethernet WAN link (also called Transparent LAN Service: TLS) by using a Pseudo-Random Bit Sequence (PRBS) pattern in order to count bit errors and derive a Bit Error Rate (BER) measurement. In the prior art, PRBS test patterns and Bit Error Rate measurements have been used for testing the integrity of TDM Digital Circuits such as DS1 or DS3 for example, but, it has never been used for testing the integrity of an Ethernet based packet communication channel such as a TLS.

Prior art Ethernet testing devices, mostly adapted for laboratory usage, traditionally use parameters such as Packet Loss Ratio. This parameter which was intended and designed to evaluate the performance of devices such as Ethernet Switches, Bridges or Routers is not best suited for the certification of TLS links when being put into service.

For example, a tariff is levied on TLS links based on specific Service Level Agreements which include the guarantee of the perfect integrity and transparency of the link being leased. This means that when the throughput for which the customer is being billed is sustained, the carried data stream shall not incur any bit errors. In this context, the frame loss parameter given by prior art devices will provide only a coarse verification of this integrity by counting lost packets. A single bit error in a transmitted packet could potentially not affect this specific parameter. Since Ethernet, as a Layer 2 medium, does not command the retransmission of data corrupted during transfer, it defers this task to higher layer protocol which are the applications being run by the customers which thus reduces the usable throughput to the customer in the event of data corruption.

Furthermore, Ethernet also provides an intrinsic coarse indication of the integrity of the packets being delivered by the use of a CRC-32 Frame Check Sequence, this indication has an accuracy of the order of One Packet (i.e. it can determine if a packet was corrupted or not but it cannot quantify this corruption).

On the other hand, the use of a PRBS test sequence (as described in TOM standard 0.153 of the ITU-T organization) being executed on the equivalent of the data bandwidth available to the TLS customer can provide a long term measurement at an accuracy of One Bit. The use of the latter technique is thus a justified improvement with regards to prior art.

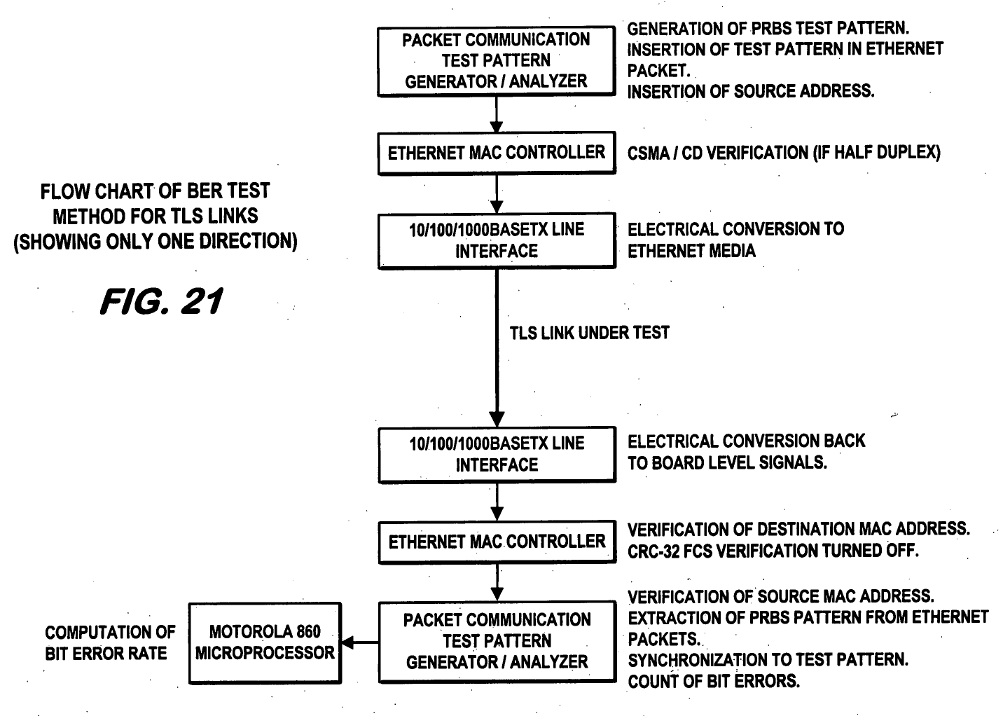

The method according to a preferred embodiment of the invention is illustrated in FIG. 21.

The “Packet Communication Test Pattern Generator/Analyzer” Generates a PRBS test pattern and contiguously fills the Data portion of a flow of Ethernet Packets with the generated bit stream. The Ethernet packets are then passed on to the “Ethernet MAC Controller”. The “Ethernet MAC Controller” then executes CSMNCD verification (if Half Duplex) and sends the packets to one of the two “10/100/1000BaseTX Line Interfaces”.

A stream of Ethernet Packets is thus transmitted as the PRBS pattern is being generated (both operations happen simultaneously in real time). The Ethernet Packets are then sent across the Ethernet link under test and recuperated at the other end by a second test set. At the receiving end, one of the two “10/100/1000BaseTX Line Interfaces” passes the received packet to the “Ethernet MAC Controller”. This one verifies the destination MAC address. In the “Ethernet MAC Controller”, CRC-32 FCS has been disabled to bypass this verification and allow the packets pass through directly and untouched to the “Packet Communication Test Pattern Generator/Analyzer”. This one verifies the source MAC address and obtains a resulting received PRBS pattern and synchronizes itself on it. This pattern, being a known sequence, allows for a precise count of bit errors and accurate computation of a Bit Error Rate by the Motorola 860 microprocessor at the receiving end.

In the case of the TLS link under test being of Half Duplex nature, the test would be run in one direction only at a time thus evaluating both directions of the link separately. In the case of the TLS link under test being of Full Duplex nature, both directions would be tested simultaneously, i.e. both test sets would simultaneously act as a receiving end and a transmitting end.

Alternatively, if the Ethernet link under test is of Full Duplex nature, a loop-back accessory (as described above) can be used in place of a second test set. The accessory then sends the packets back to the originating test set and this one then acts also as the receiving end (similarly to the loopback method described above).

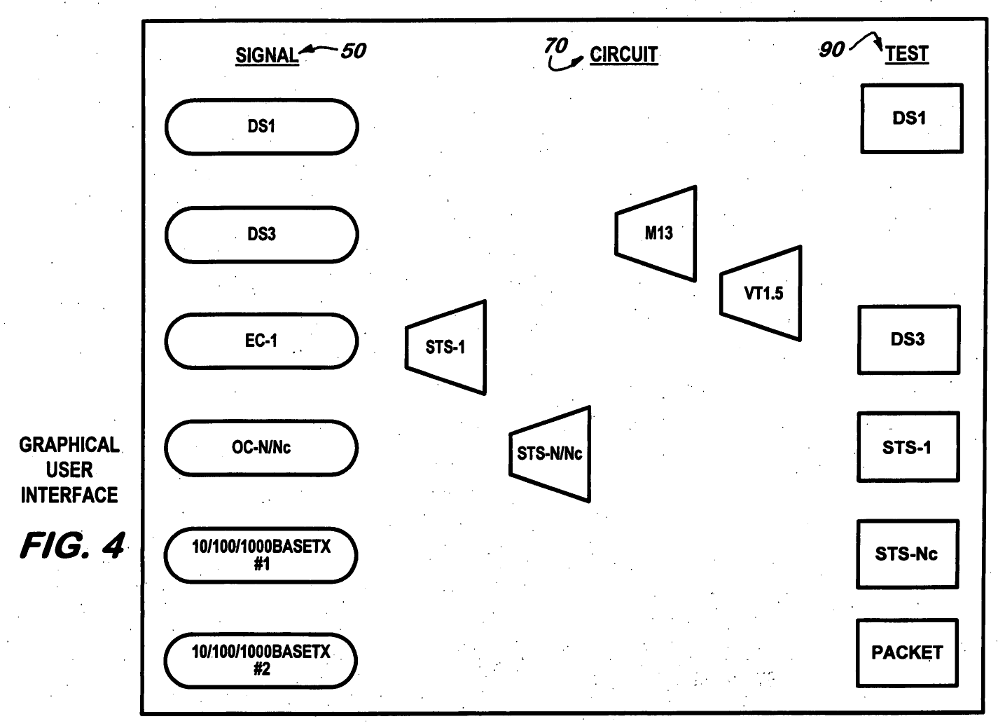

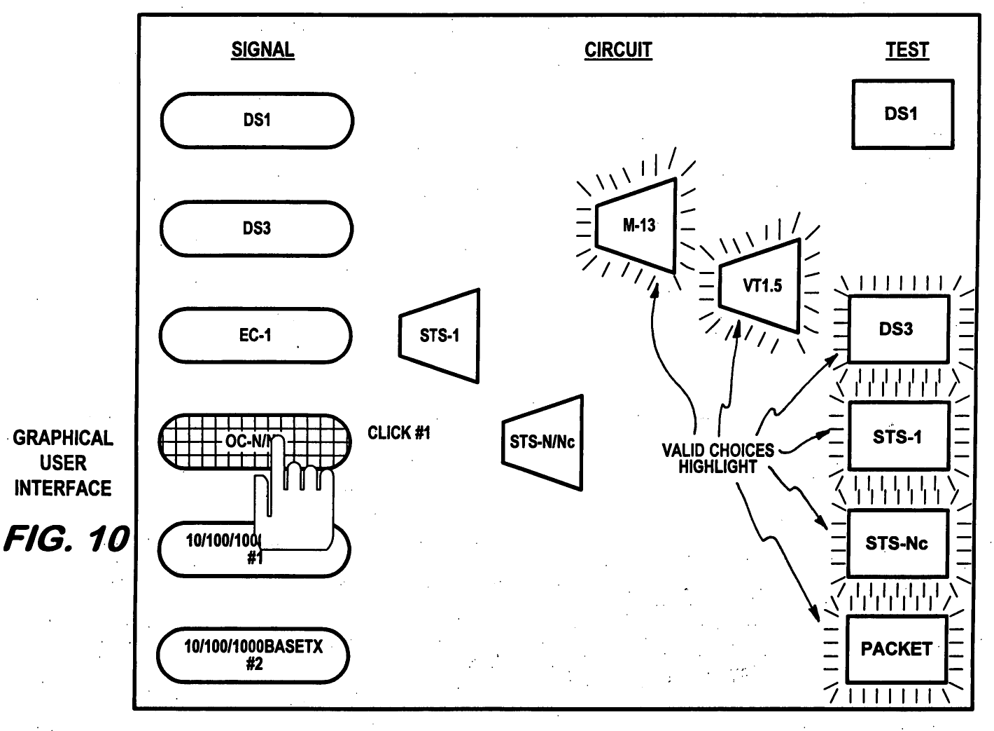

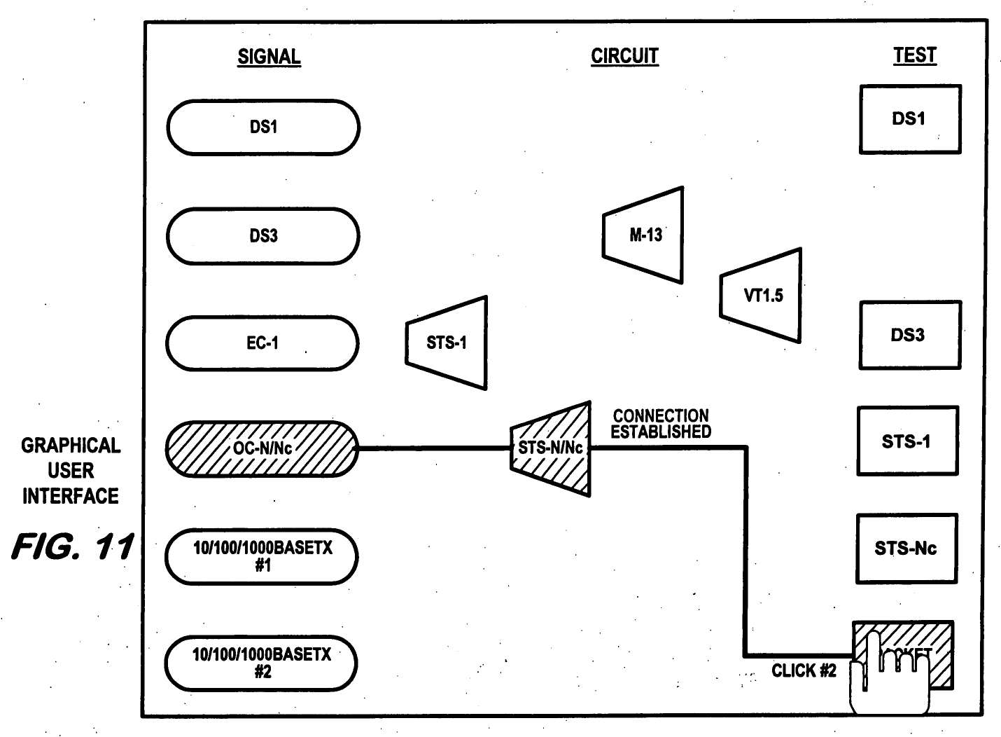

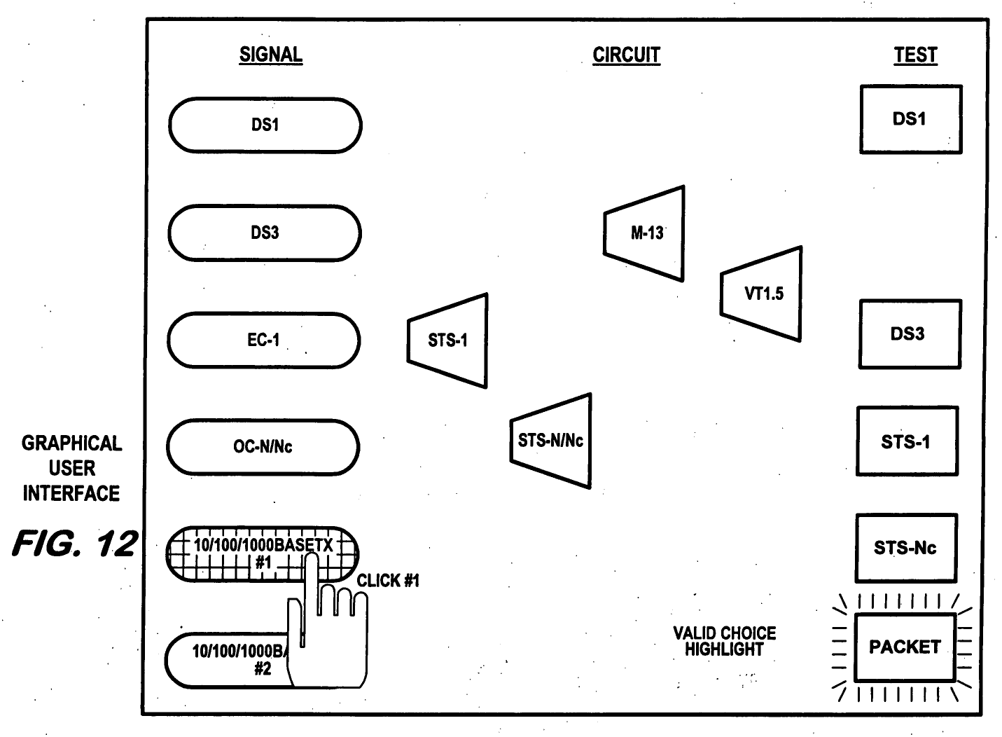

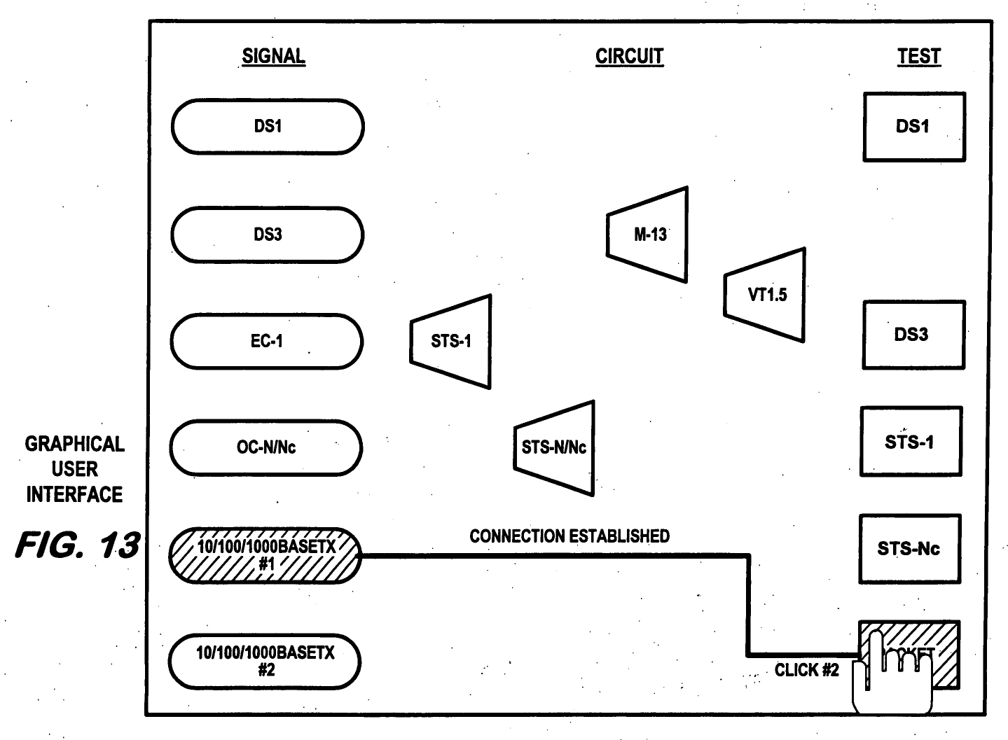

A final aspect of the present invention is a GUI for more easily performing the tests administered by the test set 10 of the present invention, which will be described in reference to FIGS. 4 to 13. The GUI display comprises three major sections: a signal field 50, a circuit field 70 and a test field 90. The signal field 50 includes six (6) icons representing the various communication signals which can be connected to the test device 10. The circuit field 70 includes four icons representing the various multiplexing steps involved in the standard TDM hierarchy. The test field 90 includes five (5) icons representing tributary traffic termination points as per the standard TOM multiplexing hierarchy, as well as a packet termination point. An important aspect of the present invention is the fact that its graphical user interface is based on the standard TOM multiplexing hierarchy, as opposed to prior art representations which are based on the internal architecture of the test device. By providing the user with a widely accepted and understood representation of the multiplexing configuration, the training required specifically for the test device itself is therefore minimized.

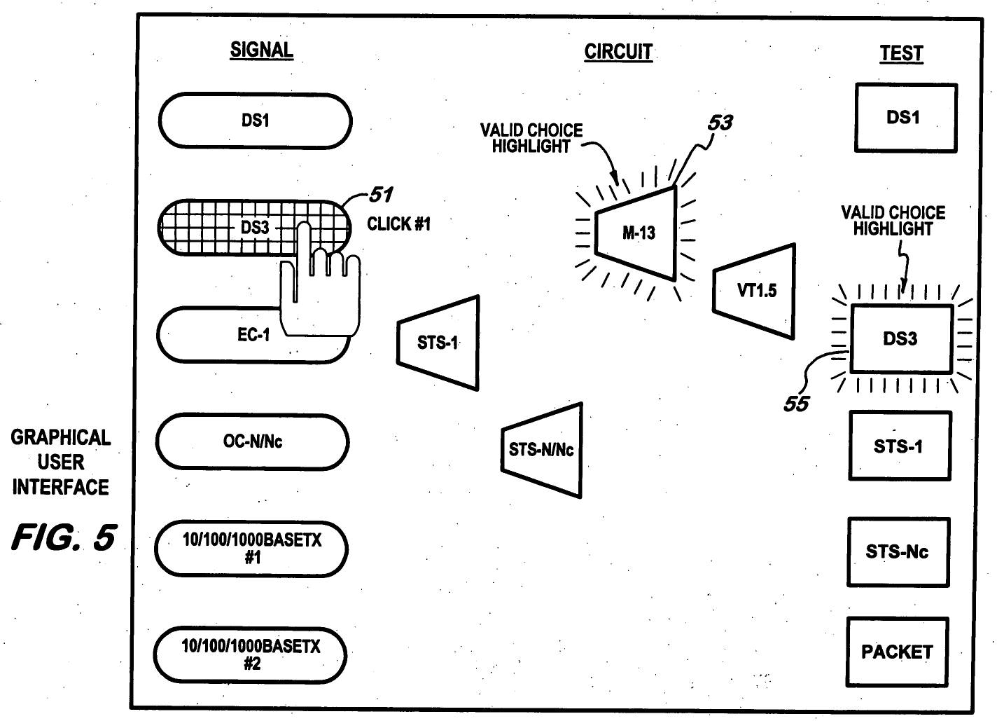

The present GUI will be better understood with the following example, which will be for demultiplexing a DS3 signal and testing an embedded DS1 tributary. For such a test, the user physically connects a DS3 signal to the test set. Therefore, intuitively, as a first step, the user touches (or clicks) on the DS3 “signal” icon 51. Instantaneously, the selected icon becomes highlighted and the valid options for the next choice are highlighted to the user in a different color (see FIG. 5). An important aspect of the present invention is the fact that the Graphical User Interface guides the user between steps by highlighting the next valid choices for the user, and ONLY those steps. Invalid steps or choices will not be validated by the test set 10 of the present invention, which reduces errors in testing, and increases the learnability of the test set of the present invention.

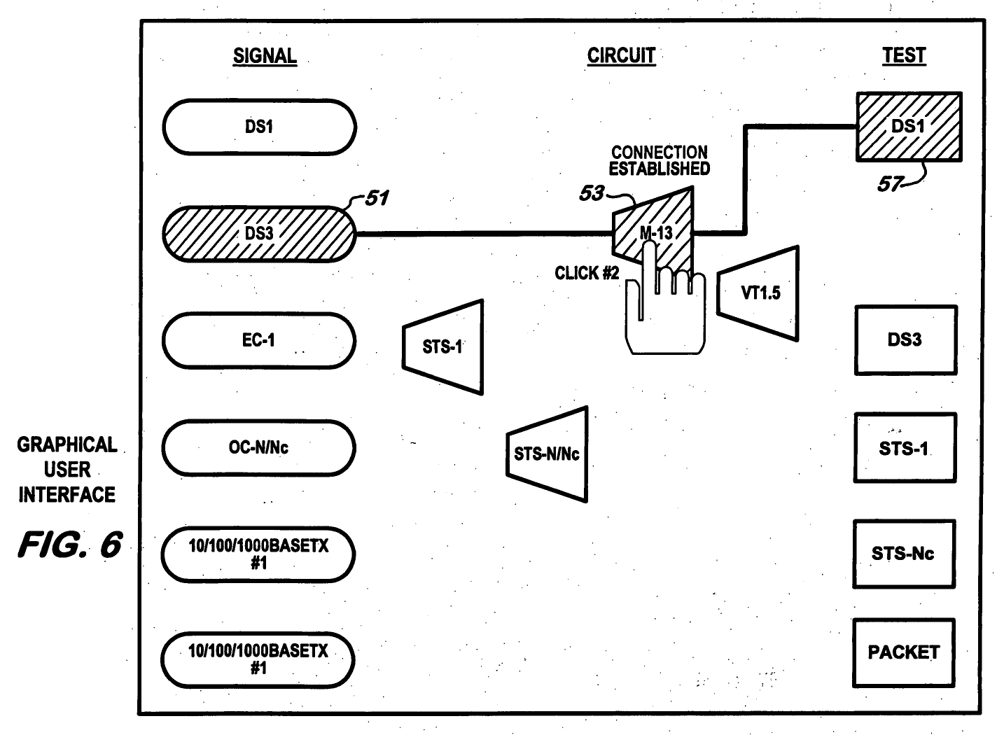

In the case of the example, the next valid steps could be either demultiplexing the DS3 signal to test an embedded DS1 tributary (by choosing the M13 “circuit” icon) or directly terminating the DS3 signal for testing (by choosing the DS3 “test” icon 55). In the present example, the user touches (or clicks) on the M13 “circuit” icon 53, as shown in FIG. 6. Instantaneously after this second step, a circuit is graphically drawn showing the connection from the DS3 “signal” icon 51 to the DS1 “test” icon 57 via the M13 “circuit” icon 53.

The key to the ease of use of this novel Graphical User Interface is the fact that the user can activate any valid test configuration with only two (2) touches on the touchscreen (or two (2) clicks of a mouse). This feature considerably reduces the number of configuration steps required to set-up for a test when compared to prior art. For the user, this results in fewer configuration errors and therefore fewer erroneous test results.

It should be understood however that the first step mentioned above could be omitted entirely. There presently exists circuitry which automatically determines if there is a physical connection present. Consequently, each of the input ports of FIG. 2 can be provided with this circuitry. Consequently, as soon as a physical connection is made, the corresponding icon in the signal field would automatically be highlighted, as well as the valid choices. The user would then only have to “one-click” his way to the appropriated circuit or test icon.

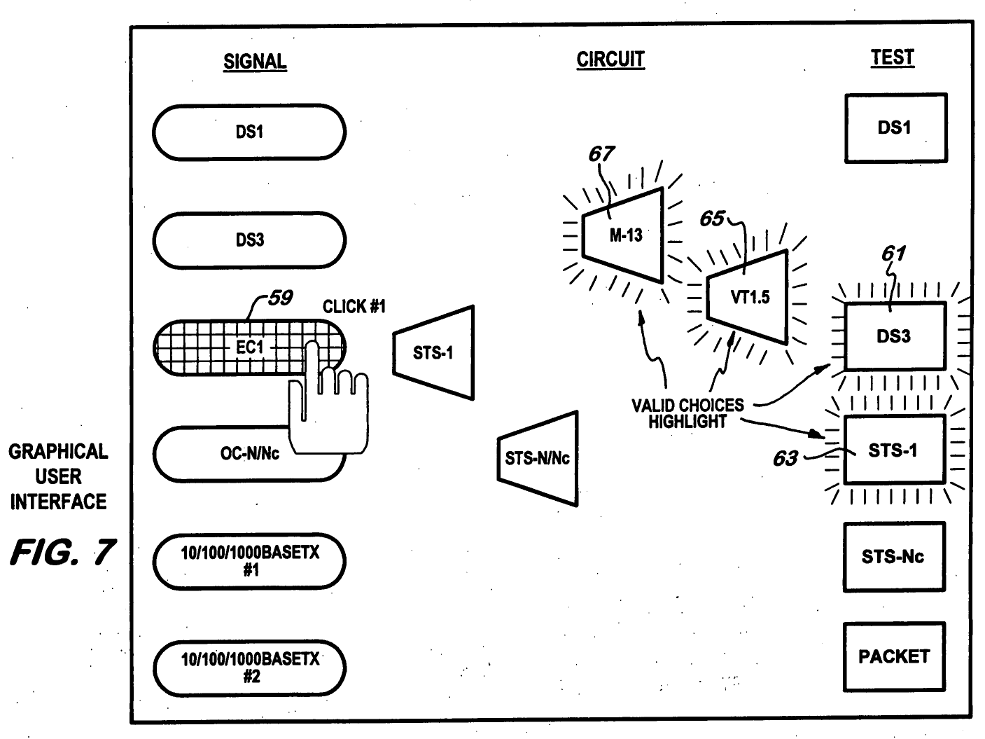

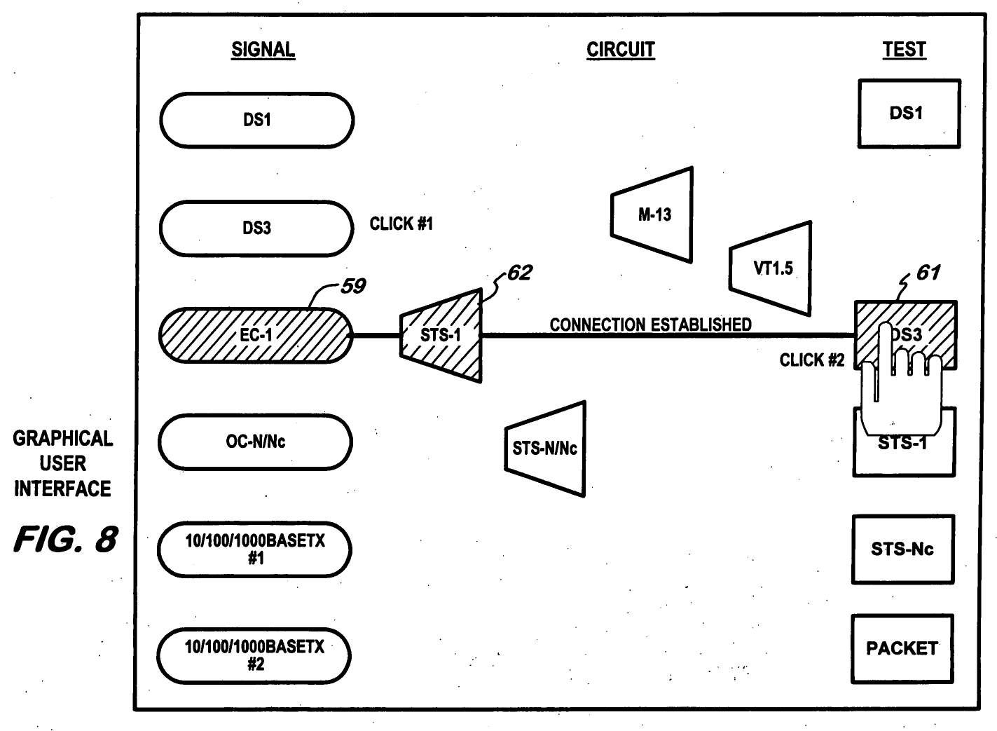

Another example is shown in FIGS. 7 and 8 show the two user inputs required to activate another test configuration, where an STS-1 (EC-1) signal is used as a starting point and an embedded DS3 signal is to be terminated and tested. For such a test, the user physically connects an STS-1 (EC-1) signal to the test set; therefore, intuitively, as a first step, the user touches (or clicks) on the EC-1 “signal” icon 59. The selected icon becomes highlighted and the valid options for the next step are highlighted to the user in a different color (see FIG. 7). In this case, the next valid steps could be either extracting and terminating a DS3 for testing (by choosing the DS3 “test” icon 61) or directly terminating the STS-I signal for testing (by choosing the STS-1 “test” icon 63) or demultiplexing an embedded DS3 to extract a DS1 for testing (by choosing the M13 “test” icon 67) or directly extracting a DS1 out of the STS-1 for testing (by choosing the VTI 0.5 icon 65).

In this example, the user will touch (or click) on the DS3 “test” icon 61 (see FIG. 8). After this second step, a circuit is graphically drawn thus linking the EC-1 “signal” icon 59 to the DS3 “test” icon 61 via the STS-1 “circuit” icon 62.

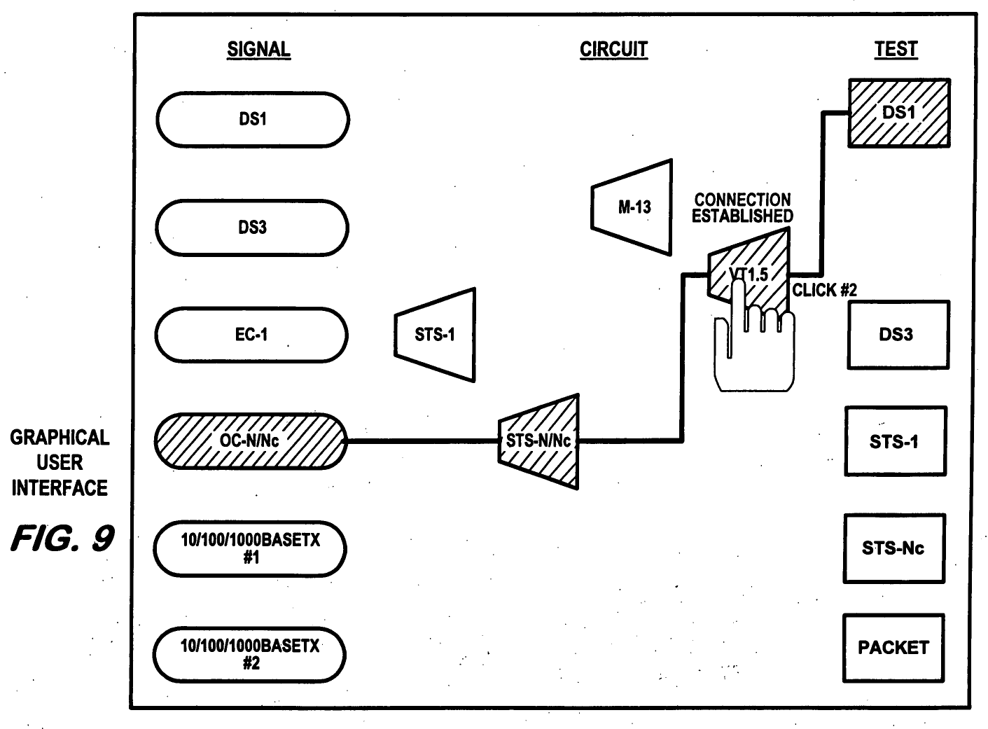

FIGS. 9 to 13 show three other similar examples for further comprehension of the principle in which the user sets up for testing DS1 out of an OC-N signal, packets out of a 10/100/1000BaseTX interface and packets out of an OC-Nc signal. This last example actually illustrates an example of interaction between the TDM communication test module and the packet communication test module in which packets are tested out of a TOM signal (OC-Nc).

Although the present invention has been explained hereinabove by way of a preferred embodiment thereof, it should be pointed out that any modifications to this preferred embodiment within the scope of the appended claims is not deemed to alter or change the nature and scope of the present invention.

1-14. (canceled)

15. A method for testing an Ethernet link comprising:
(a) generating a PRBS test pattern and filling the data portion of a flow of Ethernet packets with the PRBS test pattern using a first test set;
(b) transmitting said packets from said first test set to a second test set over an Ethernet TLS link;
(c) extracting and obtaining a resulting PRBS test pattern from the packets received at a second test set, the resulting pattern allowing for a precise count of bit errors, thereby providing a bit error rate.

16. A method according to claim 15, wherein said test is carried in one direction at a time when the communication link to be tested is half duplex.

17. A method according to claim 15, wherein said first and second test sets are adapted to perform the steps of the method simultaneously, in order to test under full duplex conditions.

18. A method according to claim 15, wherein said second test set is replaced by a loopback accessory, said loopback accessory inverting the source and destination addresses of the packets and transmitting the modified packets back to the first test set.
